(19) United States
(12) Patent Application Publication
(10) Pub. No.: US 2008/0155462 A1
(43) Pub. Date: Jun. 26, 2008

(54) Independent scrolling of tabular data

(75) Inventors: Nikhil Nilakantan, Dallas, TX (US); Jean-Yves Avenard, Surrey Hills (AU); Kiana Dezelon, Cary, NC (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/712,029

(22) Filed: Feb. 28, 2007

Related U.S. Application Data
(60) Provisional application No. 60/876,977, filed on Dec. 22, 2006.

(51) Int. Cl. G06F 3/048

(52) U.S. Cl. 715/786

(57) ABSTRACT

A method and a system for manipulating columns and/or rows of tabular data are provided. A user of an electronic device displaying tabular data is allowed to select a column and to scroll the data within that column without scrolling the other columns. In this manner, a user is able to scroll one or more columns while maintaining the display of the unselected columns. A similar method and system may be used to scroll selected rows. Embodiments of the present invention may be utilized in any type of electronic device capable of displaying tabular data, such as handheld calculators, computers, and the like.

This application claims the benefit of U.S. Provisional Application No. 60/876,977 filed on Dec. 22, 2006, entitled Independent Scrolling of Tabular Data, which application is hereby incorporated herein by reference.

### TECHNICAL FIELD

The present invention relates generally to manipulating tabular data and, more particularly, to a system and method for scrolling within tabular data displayed on electronic devices.

### BACKGROUND

Analysis frequently involves evaluating large amounts of tabular data. For example, analysis of a mathematical function may involve an analysis of independent and dependent variables organized in a tabular manner. Many times, this analysis involves creating a worksheet showing the interrelationship of independent variables and dependent variables, and may involve tabular data comprising tens or hundreds of columns and/or rows. This type of analysis is frequently performed in all types of work, such as financial models, simulations, function analysis, mathematical models, and the like.

Because the size of the tabular data may be very large, it may be difficult to scroll through the data. This problem may be particularly troublesome when using a handheld computing device with a small display size. For example, handheld calculators are widely used in professional arenas as well as in academic studies. Handheld calculators, however, have small displays, some of which range in size from 2 inches to 3.5 inches. Although desktop computing systems may have a larger display, it may be difficult to analyze tabular data comprising tens or hundreds of rows and columns.

Therefore, there is a need for a system and method to enable flexible manipulation of tabular data displayed on an electronic device.

### SUMMARY OF THE INVENTION

These and other problems are generally solved or circumvented, and technical advantages are generally achieved, by preferred embodiments of the present invention which provides independent scrolling of tabular data.

In an embodiment of the present invention, a method of manipulating a display of tabular data is provided. The method comprises displaying tabular data, selecting a selected row or column, and scrolling the selected row or column independently of other rows and/or columns.

In another embodiment of the present invention, a calculator is provided. The calculator generally includes a screen, a keypad, and a processor communicatively coupled to the screen and the keypad. The processor is configured to display a portion of tabular data on the screen in rows and columns and to select a first group of the tabular data in response to a user activating one or more selection keys of the keypad. Once selected, the processor is configured to scroll the first group independently of other groups of the tabular data in response to the user activating one or more input devices, such as directional keys, mouse, stylus on a touchscreen, or the like. The first group may include rows of the tabular data and/or columns of the tabular data.

In yet another embodiment of the present invention, an electronic device comprising a memory, a keypad, a display, and a processor is provided. The processor is configured to perform program instructions stored in the memory to display tabular data on the display and to allow a user to select a line of data and to scroll the line of data independently of other lines of data through activation of one or more keys of the keypad. The line of data may be one or more rows and/or one or more columns of tabular data.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a block diagram of a handheld computing device in accordance with an embodiment of the present invention;

FIG. 2 illustrates an example of a handheld computing device in accordance with an embodiment of the present invention;

FIG. 3 is a block diagram of a desktop computing device in accordance with an embodiment of the present invention;

FIGS. 4a-4c are screen shots illustrating scrolling of an individual column in accordance with an embodiment of the present invention;

FIGS. 5a-5b are screen shots illustrating scrolling of an individual row in accordance with an embodiment of the present invention; and

FIG. 6 is a data flow diagram illustrating a process scrolling a column or row in accordance with an embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

Embodiments of the present invention are discussed below with respect to embodiments in which a graphing calculator or a personal computer are used. It should be noted, however, that embodiments of the present invention may be useful for other types of electronic devices, handheld computing devices, desktop devices, and mainframe devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, personal communicators, personal intelligent communicators, cellular or mobile telephones, global positioning system (GPS) devices, portable inventory logging computer devices, handheld monitoring devices, handheld portable email devices, handheld portable Internet browsing devices, handheld portable gaming devices, and any combination thereof.

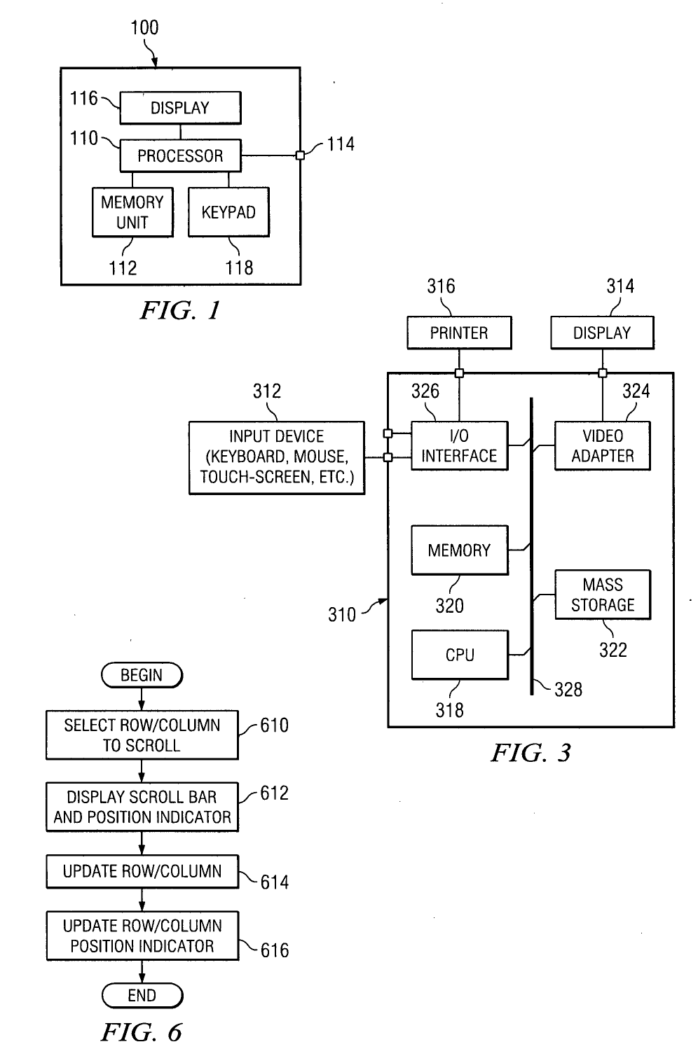

FIGS. 1 is a block diagram of a handheld computing device 100 in accordance with an embodiment of the present invention. Generally, the handheld computing device 100 includes a processor 110 connected to a memory unit 112, which may include one or both of read-only memory (ROM) and random-access memory (RAM). In a preferred embodiment, however, the handheld computing device 100 includes ROM to store software programs and RAM to store intermediate data and operating results.

An optional input/output port 114 provides connectivity to other electronic devices, such as other computers, hubs, displays, or the like. In an embodiment, the input/output port 114 comprises a bi-directional connection such as a mini-A USB port. In this manner, the handheld computing device 100 may transmit information to and receive information from another electronic device. Also included in the handheld computing device 100 are a display 116 and a keypad 118.

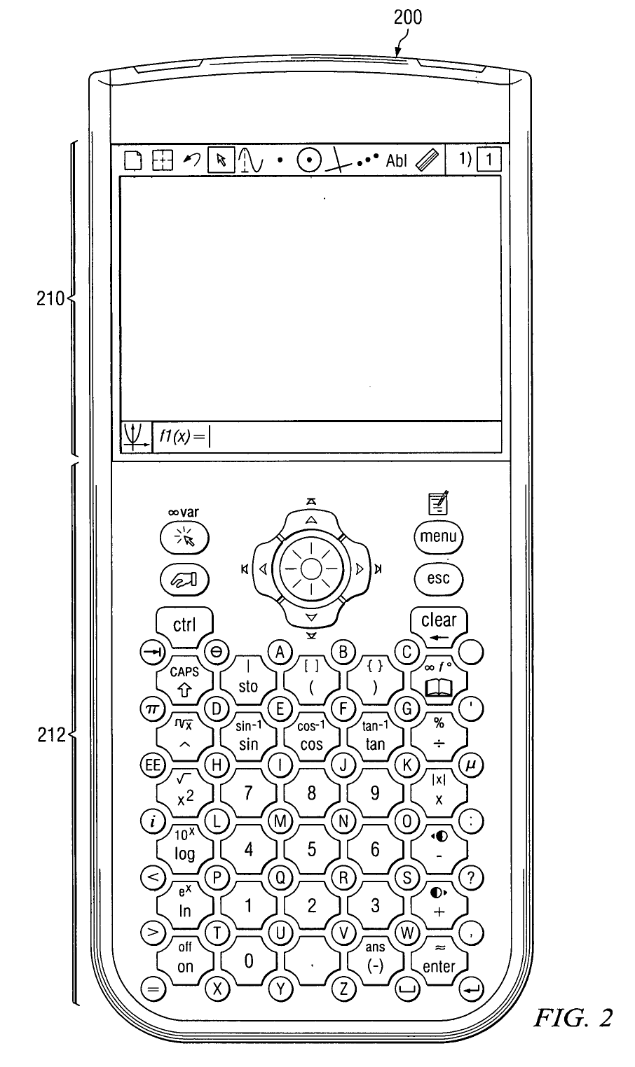

FIG. 2 illustrates a graphing calculator 200 as an example of the handheld computing device 100 illustrated in FIG. 1 in accordance with an embodiment of the present invention. For illustrative purposes only, the handheld computing device 100 illustrated in FIG. 2 is a graphing calculator. It should be noted, however, that the graphing calculator is used for illustrative purposes only and does not limit the invention as claimed.

As shown in FIG. 2, the graphing calculator 200 preferably includes a graphical display 210 and a set of keys 212. The graphical display 210 provides a means upon which graphs of various functions and/or one or more lines of text/symbols may be displayed. The graphical display 210 may be, for example, an LED or LCD display. The set of keys 212 is located below the graphical display 210 and provides a method for a user, e.g., a student, to enter data and functions. Other configurations and functions may be used.

FIG. 3 is a block diagram of a desktop computing system 300 that may also be used in accordance with an embodiment of the present invention. Generally, the desktop computing system 300 may comprise, for example, a desktop computer, a workstation, a laptop computer, a personal digital assistant, a dedicated unit customized for a particular application, or the like. Accordingly, the components of the desktop computing system 300 disclosed herein are for illustrative purposes only and other embodiments of the present invention may include additional or fewer components.

In an embodiment, the desktop computing system 300 comprises a processing unit 310 equipped with one or more input devices 312 (e.g., a mouse, a keyboard, or the like), and one or more output devices, such as a display 314, a printer 316, or the like. Preferably, the processing unit 310 includes a central processing unit (CPU) 318, memory 320, a mass storage device 322, a video adapter 324, and an I/O interface 326 connected to a bus 328. The bus 328 may be one or more of any type of several bus architectures including a memory bus or memory controller, a peripheral bus, video bus, or the like. The CPU 318 may comprise any type of electronic data processor. For example, the CPU 318 may comprise a Pentium™ processor from Intel Corp., an Athlon processor from Advanced Micro Devices, Inc., a Reduced Instruction Set Computer (RISC), an Application-Specific Integrated Circuit (ASIC), or the like. The memory 320 may comprise any type of system memory such as static random access memory (SRAM), dynamic random access memory (DRAM), synchronous DRAM (SDRAM), read-only memory (ROM), a combination thereof, or the like. In an embodiment, the memory 320 may include ROM for use at boot-up, and DRAM for data storage for use while executing programs.

The mass storage device 322 may comprise any type of storage device configured to store data, programs, and other information and to make the data, programs, and other information accessible via the bus 328. In a preferred embodiment, the mass storage device 322 is configured to store a software program to be executed by the CPU 318. The mass storage device 322 may comprise, for example, one or more of a hard disk drive, a magnetic disk drive, an optical disk drive, or the like.

The video adapter 324 and the I/O interface 326 provide interfaces to couple external input and output devices to the processing unit 310. As illustrated in FIG. 3, examples of input and output devices include the display 314 coupled to the video adapter 324 and the mouse/keyboard 312 and the printer 316 coupled to the I/O interface 326. Other devices may be coupled to the processing unit 310.

It should be noted that the handheld computing system 100 and the desktop computing system 300 may include other components. For example, the handheld computing system 100 and the desktop computing system 300 may include power supplies, cables, a motherboard, removable storage media, cases, a network interface, and the like. These other components, although not shown, are considered part of the handheld computing system 100 and the desktop computing system 300.

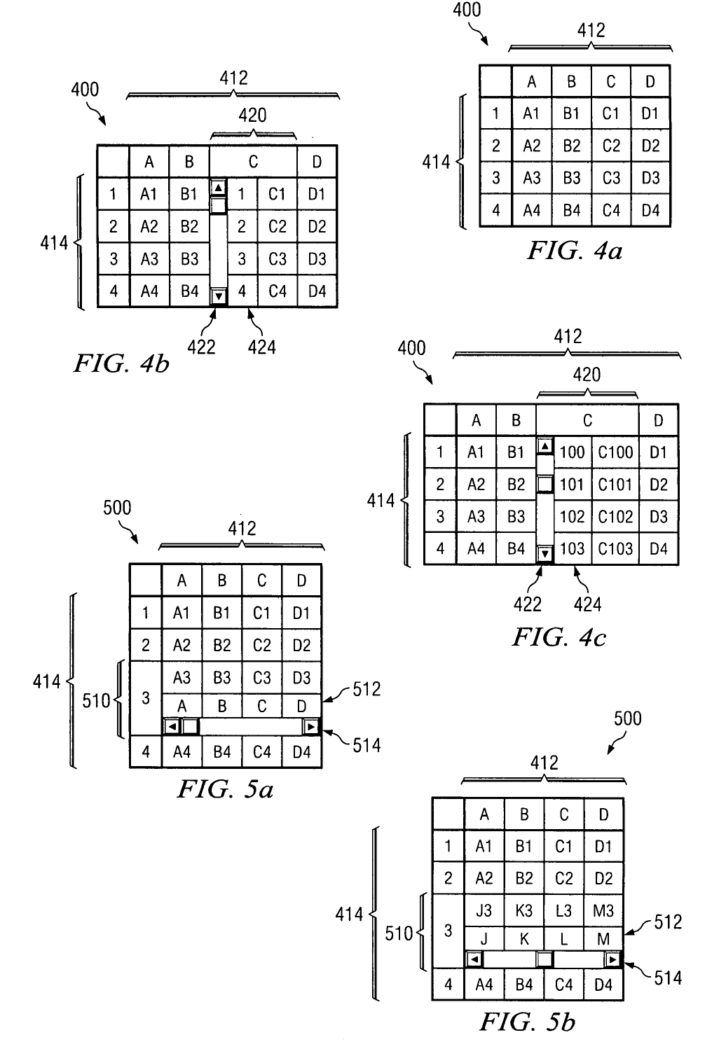

FIGS. 4a-4c are screen shots of a first embodiment of the present invention in which one or more columns are scrolled independently of other columns on an electronic device such as those discussed above with reference to FIGS. 1-3. Referring first to FIG. 4a, there is shown tabular data 400 arranged in columns 412 and rows 414, wherein the cell values are given the column/row coordinate for illustrative purposes. The tabular data 400 may be arranged such that the independent variables are arranged in rows and the dependent variables are arranged in columns, or the tabular data may be arranged such that the independent variables are arranged in columns and the dependent variables are arranged in rows. It should be noted that the screen shot illustrated in FIG. 4a illustrates only that portion of the tabular data that may be shown on a display (such as display 116 of FIG. 1 or display 314 of FIG. 3) in a readable format, and that the rows and/or columns of the tabular data may extend beyond that which is shown on the display. Fewer or more rows and/or columns may be displayed.

Referring now to FIG. 4b, a screen shot is shown after a selected column 420 (column “C” in this example) has been selected for scrolling. The selected column 420 may be selected for scrolling by any suitable mechanism, such as mouse controls, scroll buttons, one or more keystrokes, stylus in combination with a touchscreen, combinations thereof, or the like. In a preferred embodiment, scrolling controls are displayed for the selected column 420. In the embodiment illustrated in FIG. 4b, a scroll bar 422 is displayed adjacent the selected column 420 that enables a user to scroll the selected column 420 up or down. The selected column 420 may be scrolled by activation of an input device, such as directional keys, mouse, stylus on a touchscreen, combinations thereof, or the like. Additionally, an embodiment of the present invention displays an indication of the column location. For example, in an embodiment a row number indicator 424 is displayed adjacent the selected column 420 as illustrated in FIG. 4b. The row number indicator 424 comprises a column whose values within each row indicate the row number of each respective row of the selected column 420. Other mechanisms, however, may be used. For example, in another embodiment a single value may be given to indicate a specific row such as the first row, last row, or an intermediate row. In yet other embodiments, a row number indicator may be displayed for each column, and in another embodiment arrow or cursor keys may be used to control scrolling within the column.

FIG. 4c illustrates the screen shot of FIG. 4b after the selected column 420 has been scrolled down 100 rows in accordance with an embodiment of the present invention. As shown in FIG. 4c, the row number indicator 424 and the scroll bar 422 have been adjusted to indicate the row position of the selected column.

FIGS. 5a-5b are screen shots of a second embodiment of the present invention in which one or more rows are scrolled independently of other rows on an electronic device such as those discussed above with reference to FIGS. 1-3 in accordance with an embodiment of the present invention. Referring first to FIG. 5a, tabular data 500 is shown similar to the tabular data 400 illustrated in FIG. 4a, wherein like reference numerals refer to like elements, except that a selected row 510 has been selected for scrolling in FIG. 5a rather than the selected column 420 of FIG. 4a. In an embodiment, a mechanism similar to those discussed above with reference to FIG. 4b is used to select a row rather than a column for scrolling, such as mouse controls, scroll buttons, one or more keystrokes, combinations thereof, or the like.

Preferably, a column number indicator 512 and a row scroll bar 514 are displayed adjacent the selected row 510 as visual aids for the user. The column number indicator 512 indicates the current columns being displayed for the selected row 510, and the row scroll bar 514 provides a visual indication of the location of the currently displayed columns of the selected row as well as a mechanism to scroll among the various columns of the selected row 510.

As one of ordinary skill in the art will appreciate, other mechanisms may be used to scroll among the columns of the selected row and to indicate the current position. For example, in another embodiment a single value may be given to indicate a specific column such as the first row, last row, or an intermediate row, and in another embodiment arrow or cursor keys may be used to control scrolling within the row.

FIG. 5b illustrates the screen shot of FIG. 5a after the first row 510 has been scrolled to the right 10 columns in accordance with an embodiment of the present invention. As shown in FIG. 5b, the column number indicator 512 and the row scroll bar 514 has been adjusted to indicate the row position of the selected column.

FIG. 6 is a data flow diagram illustrating a method of scrolling a specific row/column in accordance with an embodiment of the present invention. The process begins in step 610, wherein a row/column is selected by the user to scroll. As discussed above, a row/column may be selected for scrolling by any suitable mechanism, such as mouse controls, scroll buttons, one or more keystrokes, combinations thereof, or the like.

Once selected, the process proceeds to step 612, wherein a scroll bar and position indicator is preferably displayed. In step 614 the displayed data is adjusted as the user scrolls. Then, in step 616, the row/column indicator is updated as the user scrolls amongst the various columns/rows.

It should be noted that the embodiment discussed above illustrates scrolling a single row or column, but embodiments of the present invention may be used to scroll multiple rows and/or columns independently of each other. It should also be noted that all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise. In other embodiments, a hardware system may be specifically designed to perform one or more of the functions described herein.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of manipulating tabular data, the method comprising:
displaying a portion of each of a plurality of groups of data in a tabular manner, the plurality of groups including a first group, the plurality of groups being aligned in a first direction;
selecting the first group; and
scrolling the first group independently of other groups of the plurality of groups.

2. The method of claim 1, wherein the plurality of groups comprises a plurality of columns and the first group is a selected column.

3. The method of claim 1, wherein the plurality of groups comprises a plurality of rows and the first group is a selected row.

4. The method of claim 1, further comprising displaying a scroll bar substantially adjacent the first group.

5. The method of claim 1, further comprising displaying a group position indicator that indicates a position of the portion of the first group being displayed within the first group.

6. The method of claim 1, further comprising selecting a second group of the plurality of groups and scrolling the second group independently of the first group and other groups of the plurality of groups.

7. A calculator comprising:
a screen capable of displaying tabular data;
a keypad having one or more directional keys and one or more selection keys; and
a processor communicatively coupled to the screen and the keypad, the processor being configured to:
display a portion of tabular data on the screen, the tabular data having a plurality of rows and a plurality of columns;
select a first group of the tabular data in response to activation of at least one of the one or more selection keys; and
scroll the first group in response to activation of the one or more directional keys, the processor scrolling the first group independently of other groups of the plurality of groups.

8. The calculator of claim 7, wherein the first group is a selected column.

9. The calculator of claim 7, wherein the first group is a selected row.

10. The calculator of claim 7, wherein the processor is further configured to display a scroll bar and to scroll the first group upon activation of the scroll bar.

11. The calculator of claim 7, wherein the processor is further configured to display a group position indicator that indicates a position of the portion of the first group being displayed within the first group.

12. The calculator of claim 7, wherein the processor is further configured to select a second group of the tabular data in response to activation of at least one of the one or more selection keys and to scroll the second group in response to activation of the one or more directional keys, the processor scrolling the second group independently of other groups of the plurality of groups.

13. The calculator of claim 7, wherein directional keys include at least one of mouse keys and arrow keys.

14. An electronic device comprising:
a memory configured to store program instructions;
a keypad;
a display; and
a processor communicatively coupled to the memory, the keypad, and the display, the processor being configured to perform the program instructions stored in the memory, the program instructions causing the processor to display tabular data on the display, the tabular data comprising a plurality of rows of data and a plurality of columns of data, and to allow a user to select data on a line of data and to scroll independently of other lines of data through activation of one or more keys of the keypad.

15. The electronic device of claim 14, wherein the line of data comprises a row of data.

16. The electronic device of claim 14, wherein the line of data comprises a column of data.

17. The electronic device of claim 14, wherein the electronic device comprises a handheld computing device.

18. The electronic device of claim 17, wherein the handheld computing device is a calculator.

19. The electronic device of claim 14, wherein the program instructions include instructions to cause the processor to display a scroll bar substantially adjacent the line of data.

20. The electronic device of claim 14, wherein the program instructions include instructions to cause the processor to display a line position indicator that indicates a position of the line of data currently being displayed within the line of data.
